(19) United States
(12) Patent Application Publication
(10) Pub. No.: US 2003/0030873 A1
(43) Pub. Date: Feb. 13, 2003

(54) High-speed adjustable multilevel light modulation

(75) Inventors: Vincent M. Hietala, Albuquerque, NM (US); Bruce C. Schmukler, Duluth, GA (US); Sungyong Jung, Marietta, GA (US)

Correspondence Address: KING & SPALDING, 191 PEACHTREE STREET, N.E., ATLANTA, GA, 30303-1763, US

(73) Assignee: Quellan, Inc.

(21) Appl. No.: 10/141,889

(22) Filed: May 8, 2002

Related U.S. Application Data
(60) Provisional application No. 60/359,542, filed on Feb. 25, 2002.
(60) Provisional application No. 60/289,674, filed on May 9, 2001.

(51) Int. Cl. H04B 10/04; H04L 25/34; H04L 25/49

(52) U.S. Cl. 359/181; 375/286

(57) ABSTRACT

A multi-level signal is produced from an input signal using a multilevel modulation technique. The input signal is encoded with a desired level code and thermometer decoded to a latch. The latch synchronizes the decoder outputs so that identical current sources can be synchronously activated and deactivated for high-fidelity signal generation around the transition point in time. The current sources are identical circuits with adjustable current settings. The adjustable current sources can be of fixed values as determined by simple electronic circuits (e.g., a resistor circuit) or be adjusted by low-speed high-resolution digital-to-analog converters. These adjustable current settings allow for the current step between levels to be adjusted as required for linearization or as desired for other system considerations. The outputs of the adjustable current sources can be added together to form a multilevel modulated output, whereby each level in the modulated signal is independently adjustable.

### PRIORITY AND RELATED APPLICATIONS

The present application claims priority to provisional patent application entitled, “High-Speed High-Fidelity Linearizing Digital-to-Analog Converter”, filed on Feb. 25, 2002 and assigned U.S. patent application Ser. No. 60/359,542 and claims priority to provisional patent application entitled, “High-Speed Multilevel Light Modulator Driver Circuit,” filed on May 9, 2001 and assigned U.S. patent application Ser. No. 60/289,674.

### FIELD OF THE INVENTION

The present invention relates to the use of complex modulation schemes in optical fiber communication systems and more particularly relates to increasing the spectral efficiency of a multilevel modulated signal transmitted over an optical fiber communication channel through the use of adjustable level spacing.

### BACKGROUND OF THE INVENTION

In virtually all fields of communications, there exists a persistent demand to transmit more data in less time. The amount of information that can be transmitted over a communications system (or through a component of that system) is referred to as the bit rate or the data throughput of the system. Traditionally, system throughput is increased by either increasing the number of channels carrying information or increasing the bit rate of each channel. In order to meet ever-increasing bandwidth demands, aggregate throughput in fiber optic transmission systems has conventionally been increased by using multiple Wavelength Division Multiplexed (WDM) channels, time-division-multiplexing (TDM), or some combination of the two techniques. WDM techniques increase the number of channels transmitted on a particular fiber, while TDM techniques increase the data rate of each individual channel.

Conventional optical fiber networks typically can deliver on the order of 10 Gigabits of data per second (10 Gb/s). Both WDM and TDM techniques have been applied to realize fiber channel bit rates well above this conventional 10 Gb/s capacity. Many fiber optic communication systems comprise multiple WDM channels simultaneously transmitted through a single optical fiber. Each of these channels operates independently at a given bit rate, B. Thus for an m channel WDM system, the system throughput is equal to m×B. Conventional Dense WDM (DWDM) systems typically operate with 40 to 100 channels. There are certain restrictions, however, that limit the aggregate power that can be transmitted through a single DWDM optical fiber (i.e., the launch power). For example, eye safety power regulations and nonlinear effects in the fiber place limits on the aggregate launch power. In addition, channel spacing limitations and per-channel launch power, effectively limit the number of WDM channels that can be combined for transmission on a single fiber.

Optical fiber networks are typically comprised of a series of links that include a transmission block, a receiver block, and a long stretch of optical fiber connecting the two blocks (i.e., the optical plant). FIG. 1 is a block diagram of a conventional m-channel WDM fiber optic transmission system link 100. The fiber optic transmission system link 100 consists of a WDM transmission block 102 (denoted as the “Head”), the optical fiber 104, and a WDM reception block 106 (denoted as the “Terminal”). The Head 102 comprises m transmitters 108-112 (labeled “Tx”) and an m-channel WDM multiplexer 114. Each transmitter 108-112 comprises an optical source (not shown) and all circuitry necessary to modulate the source with the incoming data stream. For the case of external modulation, the transmitter block also includes a modulator. The Terminal 106 comprises an m-channel WDM demultiplexer 116 and m receivers 118-122 (labeled “Rx”). Each receiver 118-122 comprises a photodetector (not shown) and all circuitry required to operate the detector and amplify the detected signal in order to output the original electrical data stream.

For 10 Gb/s transmission in optical fiber, chromatic dispersion can present a potentially significant transmission problem. Any transmitted optical signal will have a spectral width associated with it. As data rates increase for on-off key modulated signals, the spectral width of the modulated signal increases as well. Because the refractive index of a fiber medium, such as silica fiber is a function of wavelength, different components in the spectrum of the optical signal will travel at different velocities through the fiber. This phenomenon is known as chromatic dispersion, and it can present a significant source of distortion and inter-symbol interference (ISI) for high-speed optical transmission over long lengths of fiber. Conventional 10 Gb/s links of 75 kilometers or longer typically utilize some type of dispersion compensation to offset this effect. Such dispersion compensation is typically implemented in the form of dispersion-shifted fiber (DSF) that counteracts the dispersive effects of standard fiber.

In order to upgrade existing fiber optic transmission systems for 10 Gb/s signaling, dispersion compensation can become an even more complex issue. In order to realize channel data rates of 10 Gb/s and beyond, the optical fiber 104 as well as the Head 102 and Terminal 106 of the link 100 are typically upgraded to support the increased data rates. In order to increase the channel bit rates in this conventional link 100, each transmission block 102 and reception block 106 must be replaced with optical components and circuitry capable of achieving the desired bandwidths. For high-speed channel bit rates (10 Gb/s and faster), the optical fiber 104 also must often be replaced in order to compensate for signal distortions, which are more prominent at higher data rates. This process can be particularly cumbersome and costly in a long-haul link where hundreds of kilometers of fiber must be replaced. For existing long-haul optical links, the complexity and cost of replacing planted fiber often represents a prohibitive barrier for increasing channel bit rates.

Service providers seeking to optimize revenue and contain cost prefer a highly granular, incremental expansion capability that is cost effective while retaining network scalability. The ability to increase the throughput capacity of single point-to-point links or multi-span links without upgrading or otherwise impacting the remainder of the network is highly desirable from an engineering, administrative and profitability standpoint.

Dense wavelength division multiplexing (DWDM) technology currently enables high aggregate data rates in long-haul fiber optic transmission systems. The maximum power per WDM channel on a single fiber link is limited by several well-known nonlinear effects including self-phase modulation (SPM), cross-phase modulation (XPM), four-wave mixing (FWM), stimulated Brillouin scattering (SBS), and stimulated Raman scattering (SRS). Since a given fiber optic system will have inherent limits on the maximum total power that can be transmitted on a single fiber, these nonlinear effects ultimately limit the maximum number of channels, i.e., wavelengths, in a DWDM system. For many WDM systems, particularly long-haul transmission links, it is desirable to increase the number of WDM channels, thereby increasing the total aggregate data rate of the system.

In order to meet growing demands for higher data throughput in WDM fiber optic transmission systems, multilevel modulation techniques have been developed. Multilevel modulation enables the transmission of significantly higher data rates over an optical fiber communication links than is typically achievable using conventional On/Off Keying (OOK). A detailed description of multilevel modulation techniques is provided in a co-pending U.S. patent application, Ser. No. 10/032,586, also assigned to Quellan, Incorporated. Unfortunately, the use of multi-level modulation can make a transmitted signal more susceptible to nonlinearities inherent in the components of the transmission system. For example, a conventional Mach-Zender interferometer-type laser modulator can produce a non-linear response that can adversely affect the ability to transmit a multilevel modulated signal such that the signal can be accurately decoded at the receiver.

In view of the foregoing, there is a need in the art for a multilevel modulation technique that enables the reduction of non-linearities in the transmitted signal. The technique also should enable the reduction of spectral inefficiencies in the transmitted signal. Finally, the technique should enable individualized control of each level in the multilevel modulation scheme.

### SUMMARY OF THE INVENTION

In the present invention, a multilevel signal is produced from a digital input signal using a multilevel modulator. The input signal is encoded with a desired level code and thermometer decoded to a latch. The latch synchronizes the decoder outputs so that identical, adjustable current sources can be synchronously activated and deactivated for high-fidelity signal generation around the transition point in time. The current sources are identical circuits with adjustable current settings. The adjustable current sources can be of fixed values as determined by simple electronic circuits (e.g., a resistor circuit) or be adjusted by low-speed high-resolution digital-to-analog converters. These adjustable current settings allow for the current step between levels to be adjusted as required for linearization or as desired for other system considerations. The outputs of the adjustable current sources can be added together to produce a multilevel modulated output current, whereby each level in the modulated signal is independently adjustable.

In one aspect of the present invention, a method is provided for representing a digital input word as a multilevel modulated output signal having n levels. The method includes encoding the digital input word into a code having at least one bit, switching a plurality of output sources corresponding to at least one bit of the code, and independently adjusting each of the output sources. The output sources are added to generate the multilevel modulated output signal.

In another aspect of the present invention, a multilevel modulator is provided for transmitting an output signal representing a digital input word having n bits over an optical fiber communication system. The multilevel modulator includes an encoder circuit for associating the digital input word with a multilevel modulated output code and at least one independently adjustable current source for representing each bit of the output code as a current level. The multilevel modulator also includes a current adder for combining the current levels of the at least one independently adjustable current source to generate the output signal.

In yet another aspect of the present invention, a transmitter for use in an optical fiber communications system is provided. The transmitter includes a multilevel modulation circuit operative to encode an input word into a multilevel modulated output code. The multilevel modulation circuit has a plurality of independently adjustable current sources. Each current source corresponds to at least one bit of the output code. The output of the current sources are added to generate the output signal. An optical source transmits the output signal over a link of the optical fiber communications system.

In still another aspect of the present invention, a method is provided for representing a digital input word as a multilevel modulated output signal having one of a plurality of output levels. An input word is received and the input word is encoded into a code corresponding to one of the plurality of output levels. The code controls a plurality of associated signal sources. A source output is generated for each signal source. The source outputs are independently adjusted and the source outputs are combined to generate the multilevel modulated output signal.

The various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a block diagram of a conventional m-channel WDM fiber optic transmission system.

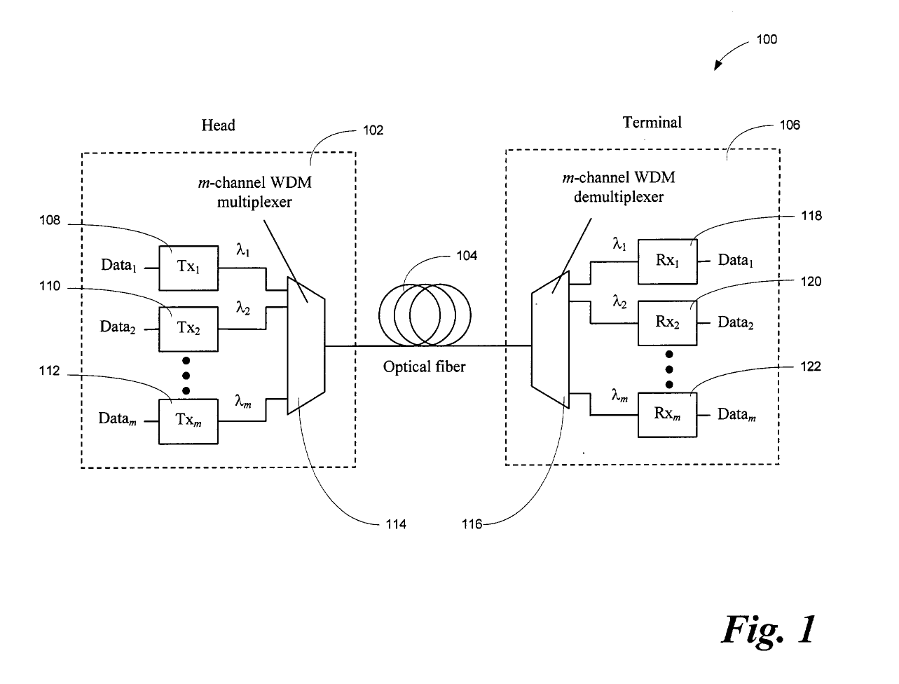

FIG. 2 is a block diagram depicting an exemplary operating environment in which an exemplary embodiment of the present invention can be implemented as a component of an encoder.

FIG. 3 is a graph depicting an exemplary 16-level multilevel modulated signal over an arbitrary time period.

FIG. 4 is a graph depicting an exemplary Mach-Zender response curve.

FIG. 5 is a graph depicting exemplary normalized drive voltages used to produce a linearized Mach-Zender response curve.

FIG. 6 is a graph depicting exemplary current source steps used to produce the linearized Mach-Zender response curve depicted in FIG. 5.

FIG. 7 is a schematic diagram of a traditional laser driver circuit.

FIG. 8 is a schematic diagram of a multilevel laser driver that is an exemplary embodiment of the present invention.

FIG. 9 is a schematic diagram of an adjustable binary-weighted multi-output current source laser drive circuit that is an exemplary embodiment of the present invention.

FIG. 10 is a block diagram depicting the architecture of an exemplary embodiment of the present invention.

FIG. 11 is a schematic diagram of an exemplary embodiment of a switched controlled current source.

FIG. 12 is a schematic diagram of an adjustable binary-weighted multi-output current source laser drive circuit for a Mach-Zender interferometer-type laser modulator that is an exemplary embodiment of the present invention.

FIG. 13 is a schematic diagram of an adjustable binary-weighted multi-output current source laser drive circuit for a direct-modulation laser diode that is an exemplary embodiment of the present invention.

### DESCRIPTION OF EXEMPLARY EMBODIMENTS

In an exemplary embodiment of the present invention, a multi-level signal is produced from a digital input signal using a multilevel modulator. The input signal is encoded with a desired level code and thermometer decoded to a latch. The latch synchronizes the decoder outputs so that identical, adjustable current sources can be synchronously activated and deactivated for high-fidelity signal generation around the transition point in time. The current sources are identical circuits with adjustable current settings. The adjustable current sources can be of fixed values as determined by simple electronic circuits (e.g., a resistor circuit) or be adjusted by low-speed high-resolution digital-to-analog converters. These adjustable current settings allow for the current step between levels to be adjusted as required for linearization or as desired for other system considerations. The outputs of the adjustable current sources can be added together to produce a multilevel modulated output current, whereby each level in the modulated signal is independently adjustable.

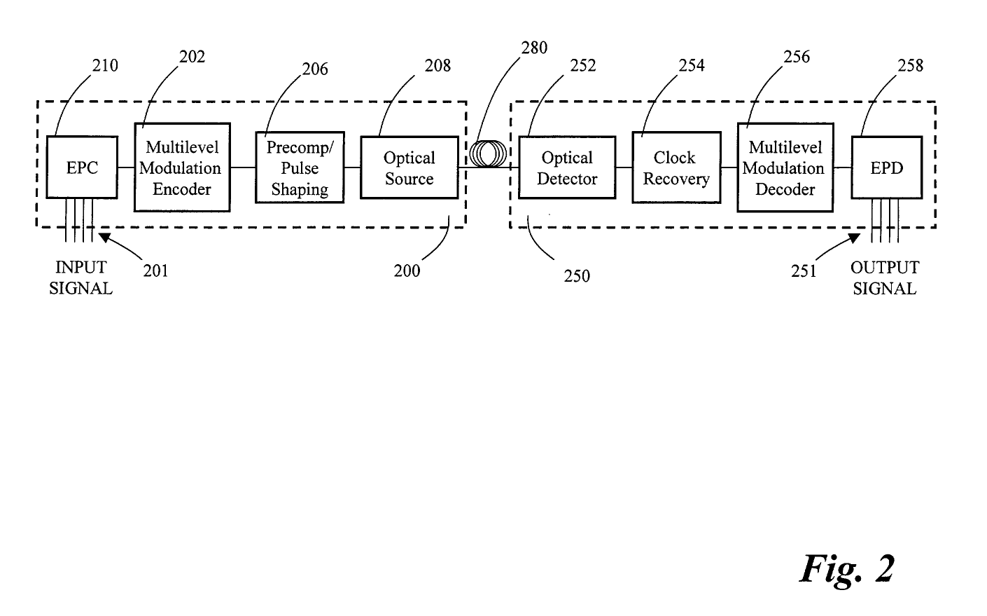

FIG. 2 is a block diagram depicting an exemplary operating environment in which an exemplary embodiment of the present invention can be implemented as a component of a multilevel modulation encoder. Specifically, an exemplary embodiment of the present invention can be implemented as a multilevel modulator in an optical fiber communication link. FIG. 2 depicts an exemplary multilevel ASK optical transmitter 200 that can transmit an optical signal over an optical fiber 280 to a multilevel ASK optical receiver 250. The transmitter 200 typically receives m input sources 201 and can include an error protection coding (EPC) module 210, an m-channel multilevel modulation encoder 202, which may include a Digital to Analog Converter DAC (not shown), a pre-compensation or pulse shaping circuit 206, and an optical source 208. The combination of the error protection coding (EPC) module 210, m-channel multilevel modulation encoder 202, and pre-compensation/pulse shaping circuit 206 may be referred to as a symbolizer. The optical source 208 may include an optical device, such as a laser diode and a driver circuit operative to enable the optical device to represent the output of the symbolizer. The multilevel modulation encoder 202 can map an m-bit word (that consists of a single bit from each of the m input data streams) into an n-bit word where n≧m. The input data can be processed by the EPC module 210 so that when decoded in the receiver 250, the processed data is error protected against bit errors introduced by the encoding/transmission/decoding process.

Pre-distortion of the transmitted data can help compensate for non-ideal link frequency response and for some classes of link non-linearities, effectively reducing pattern-dependent errors in the transmitted data. Hence, this technique is often referred to as pre-compensation and can be performed by the pre-compensation/pulse shaping module 206. Additionally, the pre-compensation/pulse shaping module 206 may perform pulse-shaping to maximize the dispersion distance (i.e., distortion-free transmission distance) of the signal in the optical fiber 280.

The receiver 250 typically includes an optical detector 252, a clock recovery module 254, an n-channel multilevel modulation decoder 256, which can include an Analog to Digital Converter ADC (not shown), and an error protection decoding (EPD) module 258. The combination of the clock recovery module 254, n-channel multilevel modulation decoder 256, and EPD module 258 may be referred to as a desymbolizer. The electronics of receiver 250 are termed the “desymbolizer”, because they convert the received symbols back into one or more digital output data streams. The symbolizer may also include post-compensation circuitry (not shown) to further improve the recovered signal received from the transmitter 200.

The n-channel decoder 256 converts the received multilevel signal into a stream of n-bit words. The clock recovery circuit 254 can be used to generate the necessary timing signal to operate the encoder 256 as well as to provide timing for output synchronization. The clock recovery circuit 254 passes the multilevel signal and timing information to the multilevel modulation decoder 256. The n-bit words can be input to the EPD module 258, which converts a coded n-bit word for each clock cycle into the corresponding m-bit word that was initially input to the transmitter 200. The original data input to the transmitter 200 can then be obtained from the EPD 258 by decoding the error protected data using the redundant bits introduced by the transmitter's EPC 210 to correct errors in the received data. The EPD 258 can output the data in m digital data streams, as the data was originally input to the transmitter 200.

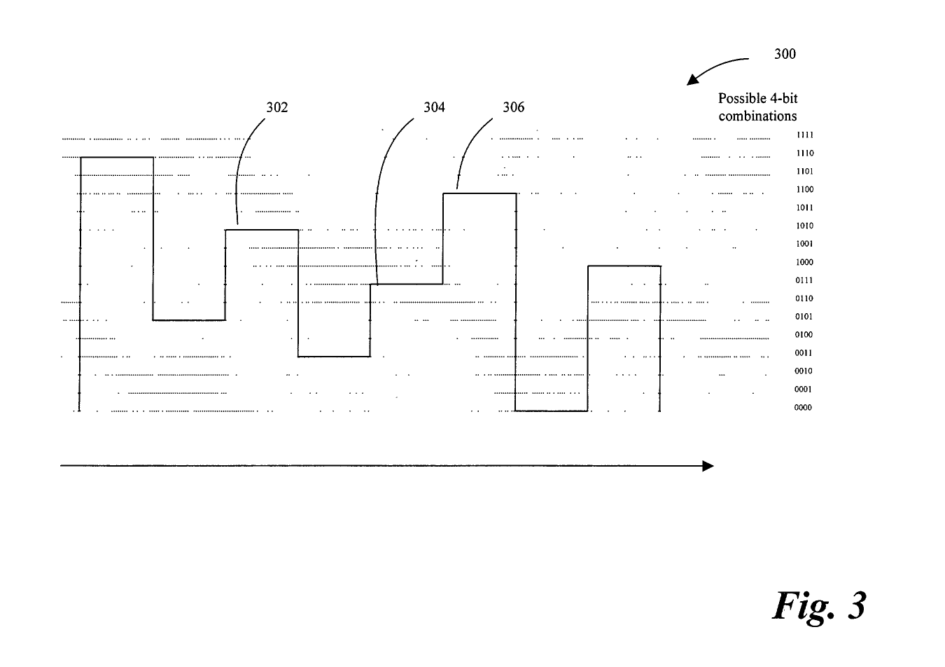

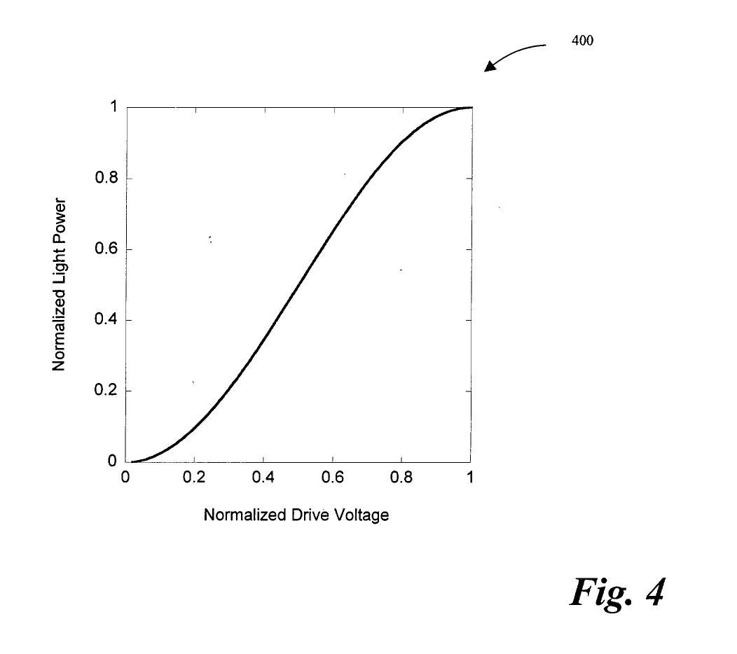

FIG. 3 depicts an exemplary multilevel ASK signal 300, combining four bits (i.e., 16 possible amplitude levels) into each single transmitted pulse, or symbol. A multilevel signal allows for more than one bit to be transmitted per clock cycle, thereby improving the spectral efficiency of the transmitted signal. For multilevel optical transmission, some characteristic (i.e., signal property) of a transmitted pulse (such as amplitude, phase, etc.) is modulated over 2ⁿ levels in order to encode n bits into the single pulse, thereby improving the spectral efficiency of the transmitted pulse. Multilevel modulation can increase aggregate channel throughput by combining n OOK data streams (each with bit rate, B, in bits/s) into one 2ⁿ-level signal (with a symbol rate, B, in symbols/s) for an aggregate throughput (in bits/s) that is n times greater than B. The aggregate data rate of the signal shown in FIG. 4 is four times greater than a corresponding OOK signal with a bit rate equal to the multilevel symbol rate. As the simplest case, OOK can be regarded as a two level multilevel signal where the symbol rate and bit rate are equal.

As a specific example, the assumption may be made that the 16-level signal in FIG. 3 has a symbol rate of 2.5 Gsym/s. That is, a pulse e.g., 302-306 with one of 16 possible amplitudes is transmitted at a rate of 2.5 Gigapulses/s. Therefore, the aggregate data rate of the 16-level signal is actually 10 Gb/s (4×2.5 Gb/s) because each pulse (i.e., symbols) can represent a distinct value of four bits. The optical components required to transmit and receive a 16-level 2.5 Gsym/s signal are nearly identical to those required for transmitting and receiving an OOK 2.5 Gb/s signal. The components are at least a factor of two times less costly than the components required for an OOK 10 Gb/s signal. In addition, the 2.5 Gsym/s signal, while providing an aggregate throughput of 10 Gb/s, is less susceptible than an OOK 10 Gb/s signal to dispersion limitations in the fiber, minimizing the need for dispersion compensation in the system, and in some cases allowing installed links to operate at higher data rates than possible without multilevel signaling. These factors can significantly reduce system costs while realizing high-speed optical links.

The improved spectral efficiency and reduced system costs afforded by multilevel amplitude modulation are offset to some degree by a corresponding degradation in the signal-to-noise ratio (SNR) of the signal due to the reduced energy separation between signals. For example, modeling channel distortions as additive, white Gaussian noise (independent of the transmitted signal), the received power penalty necessary to achieve the same error performance for a multilevel ASK signal compared to an OOK signal with equal symbol rate is described by the equation:

ΔP=−10 log(2ⁿ−1)

where ΔP is the penalty (in dB) and 2ⁿ is the number of levels. This penalty compares the proposed approach using a data rate n times faster than the baseline OOK modulation. One can also compare the two methods using the same data rate. The power penalty for this case is:

ΔP′=−10 log([2ⁿ−1]/n)

The penalty is lower for this constant data rate comparison because the reduced symbol period of conventional OOK signaling. This penalty is further reduced if the lower bandwidth of the multilevel signal, which allows for higher out-of-band noise suppression, is accounted for. The penalty ΔP′ does not take into account the effects of dispersion. These effects are negligible at data rates on the order of 2.5Gb/s but can be quite significant at data rates 10 Gb/s and higher. Thus, the penalty ΔP′ is overstating the penalty associated with multilevel signaling because the signal model for the high rate OOK scheme neglects the significant effects of dispersion. In any event, there is a basic significant penalty associated with multilevel signaling. Additional penalties associated with device nonlinearities and not ideal level spacing can not be tolerated.

The use of multilevel modulation in the context of optical fiber communication described in much more detail in a co-pending U.S. patent application, Ser. No. 10/032,586, also assigned to Quellan, Incorporated, which is hereby incorporated by reference. However, many of the adverse side-effects described above can be overcome through the use of a level-by-level adjustable multilevel modulation technique that is an exemplary embodiment of the present invention.

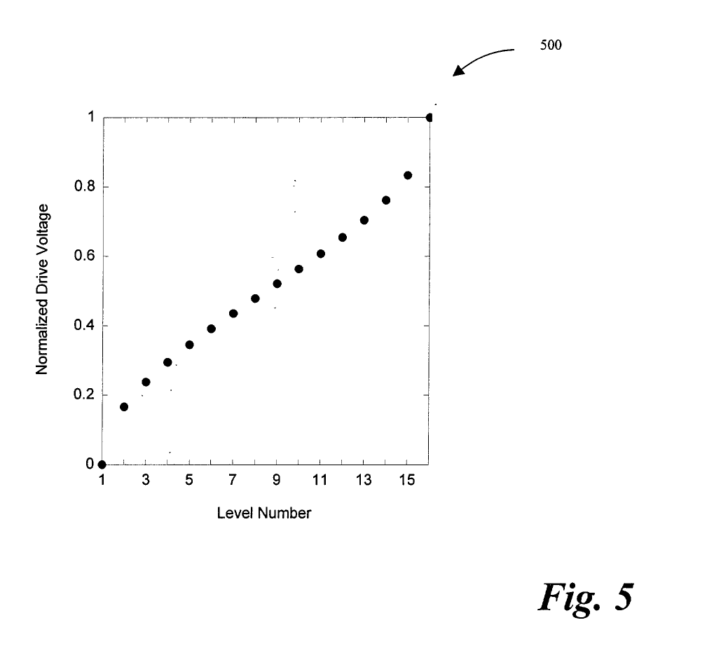

FIG. 4 is a graph depicting the theoretical response curve 400 (light vs. drive voltage) of a conventional Mach-Zehnder interferometer light modulator. The response is typically sinusoidal with an applied voltage bias. In order to generate evenly-spaced levels in a multilevel modulation scheme, it is helpful if the response curve can be linearized. As will be described in more detail below, the current output of the multilevel modulator of an exemplary embodiment of the present invention can be converted to a voltage output by the use of a simple resistor. In order to produce, for example, a 16-level maximum-amplitude linear light output the drive voltage must be provided as shown in FIG. 5.

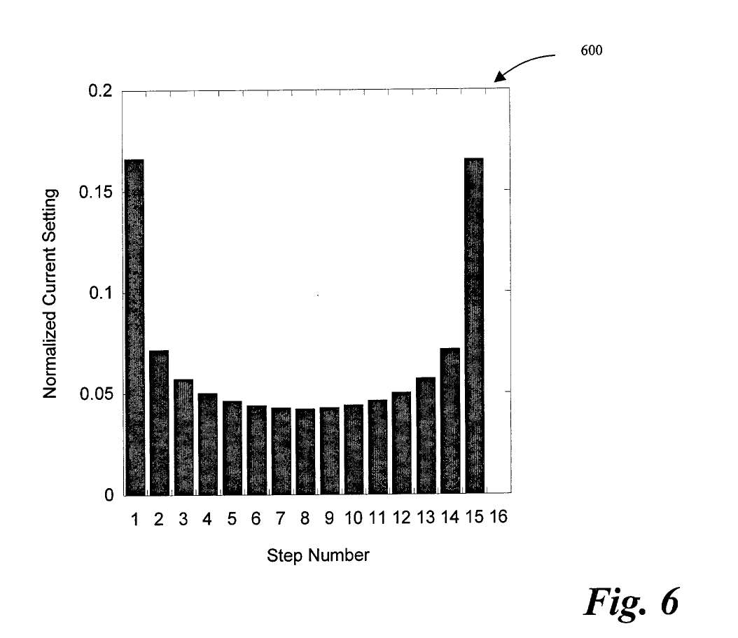

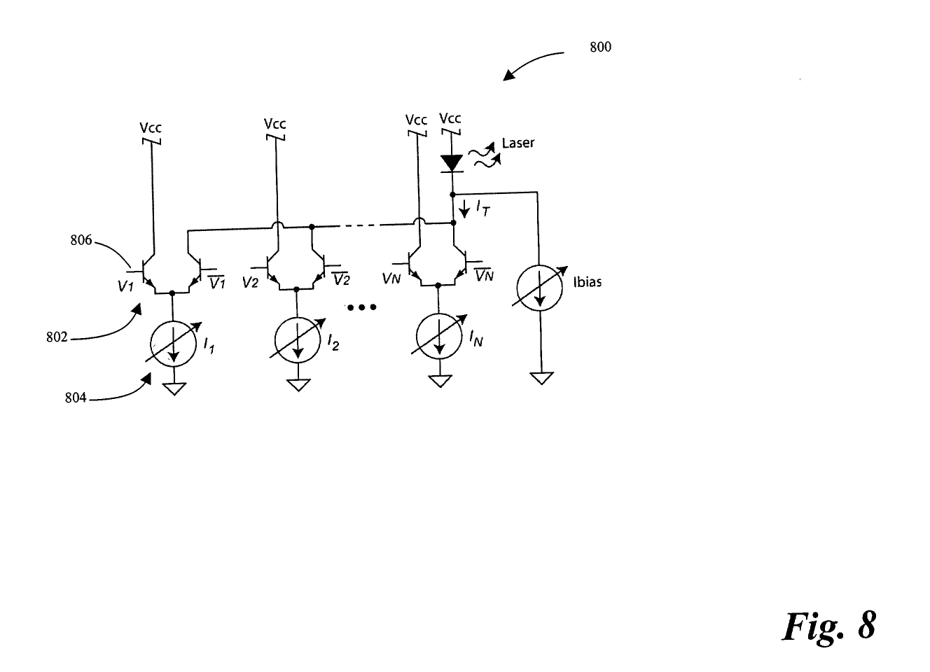

FIG. 5 is a graph depicting exemplary normalized drive voltage outputs 500 used to produce a linearized Mach-Zender response curve. The necessary normalized voltage step amplitudes 600 required to produce the voltage outputs of FIG. 5 are shown in FIG. 6. The current levels at the boundaries of the response curve have been modified (i.e., increased and decreased) to counteract the natural curvature of the response curve of FIG. 4. To achieve tuning control over the current steps depicted in FIG. 6, the current source associated with each level in the multilevel modulator can be adjustable. These individual current settings can be associated with each of the corresponding current sources, described below in connection with FIGS. 8-13, to produce the desired linear light output levels. Those skilled in the art will appreciate that these necessary current settings could be set manually or automatically. For example, the current settings could be adjusted in an adaptive manner, whereby an analysis of the multilevel modulation output could be used to adjust the current source associated with a particular level or multiple levels. Those skilled in the art will appreciate that the levels used for a multilevel communication system may be dictated by other considerations such as the signal-dependent noise properties of the system. Nevertheless, being able to linearize the transmission source is a significant advance over the prior art and can be performed in conjunction with subsequent adjustments of the multilevel modulation technique to meet other system requirements. An additional feature of the use of a large plurality of output current sources is the feasibility of obtaining large drive currents. High-fidelity operation is possible with 100 mA output current levels at Gsym/s speeds.

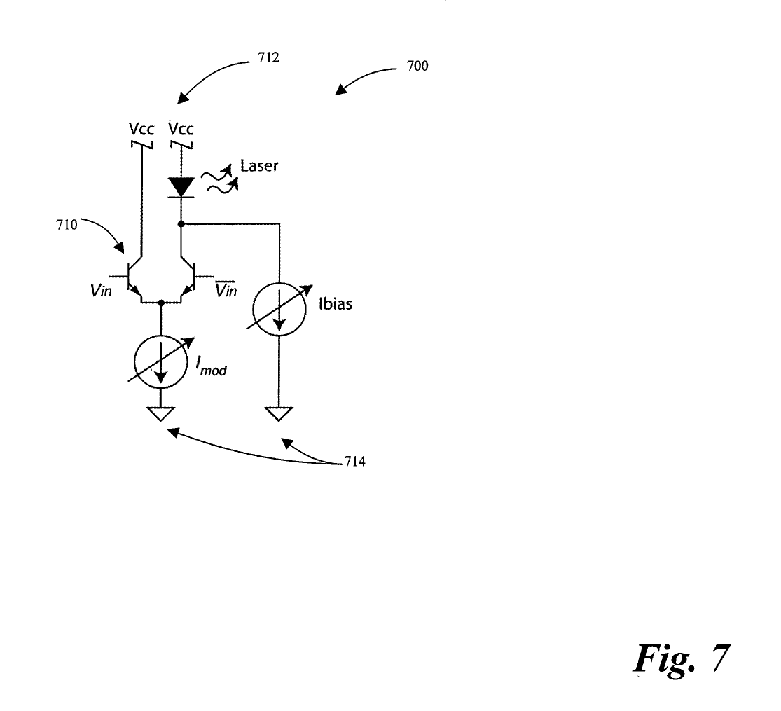

FIG. 7 is a schematic diagram of a traditional laser driver circuit. The driver circuit 700 depicted in FIG. 7 uses bipolar transistors (BJT, HBT). However, those skilled in the art will appreciate that field effect transistors (FET, MESFET, MOSFET, HEMT, PHEMT, MHEMT) also could be used. The transistors form a simple differential switch 710 that selectively applies the I_{mod} current to the laser. The current sources are generally made using current mirrors formed from the same transistor technology. The driver circuit 700 can operate from a positive supply as shown, or from a negative supply where the Vcc connections 712 become ground and the ground connections 714 become a negative supply, or any combination of positive and negative supplies. During operation, the I_{bias} supply delivers a continuous fixed current to the laser. This is often necessary to ensure proper laser dynamic performance and is commonly termed the “pre-bias” current. The laser's current is modulated by an amount set by I_{mod} by the data stream applied to the Vin terminal and Vin′ terminal on the differential switch 710. The conventional laser driver 700 only operates the laser in one of two states: “Off” with the output current being I_{bias} and “On” with the output current being I_{bias}+I_{mod}.

The conventional laser driver cannot support multilevel current control for complex, multilevel modulations techniques. Accordingly, various exemplary embodiments of the present invention are directed to providing a high-speed light modulation technique that can support binary, level-by-level control of the modulation currents for the light source.

FIG. 8 is a block diagram depicting an exemplary embodiment of a multilevel modulator 800, which can best be used to directly drive a laser diode. The circuit of FIG. 8 is similar to the conventional laser driver circuit 700 of FIG. 7 with the exception that the differential switch transistors (e.g., 802) and modulation current source (e.g. 804) are divided up into N appropriately binary-divided components. Accordingly, the multilevel driver 800 can exhibit very similar speed properties as a conventional driver 700.

During circuit operation, the individual N bits (Aᵢ) of a binary encoded binary word, A, are individually applied to the respective differential switch inputs (e.g., 806). A binary word is assumed to be made up of N bits (A_{N}, A_{N-1}, . . . A₂, A₁) of value 0 to 1, and the decimal value, D_{w}, of the word is shown in Equation 1:

$${D}_{W} = {A}_{N} \cdot {2}^{N - 1} + {A}_{N - 1} \cdot {2}^{N - 2} + … + {A}_{2} \cdot 2 + {A}_{1} = {\sum }_{i = 1}^{N} {A}_{i} \cdot {2}^{i - 1} \qquad ( 1 )$$

Those skilled in the art will appreciate that this is the conventional definition of a binary encoded word. The corresponding differential inputs for each ith binary bit, Aᵢ, are labeled Vᵢ and Vᵢ′ to represent the fact that the actual voltages used to represent the binary levels may not be conventional 0 and 1 values. Nevertheless, it is assumed that the differential switch is driven appropriately for one of each of the switches' transistors to be “on” for any given logic state.

The current sources I₁ through I_{N} are binary weighted as follows in Equation 2:

$${I}_{i} = \frac{{I}_{mod}}{{2}^{N} - 1} \cdot {2}^{i - 1} , \qquad ( 2 )$$

where I_{mod} is the modulation current of the conventional laser driver circuit. The N individual bits of the applied binary word drive the respective switch that controls the current source determined in Equation (2). This results in a total current, I_{T}, of Equation 3:

$${I}_{T} = {\sum }_{i = 1}^{N} {A}_{i} \cdot {I}_{i} = {\sum }_{i = 1}^{N} {A}_{i} \cdot \frac{{I}_{mod}}{{2}^{N} - 1} \cdot {2}^{i - 1} \qquad ( 3 )$$

Grouping the constant terms in Equation (3) gives the definition of total current shown in Equation 4:

$${I}_{T} = K \cdot {\sum }_{i = 1}^{N} {A}_{i} \cdot {2}^{i - 1} \qquad ( 4 )$$

in which the constant K is defined in Equation 5:

$$K = \frac{{I}_{mod}}{{2}^{N} - 1} \qquad ( 5 )$$

Comparing Equation (4) to Equation (1) shows that the resulting total output current, I_{T}, is a perfect analog representation of the decimal value of the binary word.

The speed of the multilevel modulation driver 800 can be similar to the speed of the conventional driver 700 if the differential switches 802 and current sources 804 are appropriately scaled for device size. The size of the transistors 802 used for the circuit 800 directly impacts circuit speed. In general, the smaller the transistors used to perform a circuit's function, the faster the circuit. For the i current paths of the modulator, the current level through each path is proportional to 2ⁱ⁻¹. Therefore, the transistor sizes, Sᵢ, of both the differential switches 802 and current sources 804 can be scaled by as shown in Equation 6:

$${S}_{i} = \frac{{S}_{o}}{{2}^{N} - 1} \cdot {2}^{i - 1} , \qquad ( 6 )$$

where S₀ is the size of the conventional laser drivers transistors (FET width or BJT area). With this device scaling, the total device size of all current paths, which is a good indicator of circuit speed is defined in Equation 7:

$${S}_{T} = {\sum }_{i = 1}^{N} {S}_{i} = \frac{{S}_{o}}{{2}^{N} - 1} {\sum }_{i = 1}^{N} {2}^{i - 1} ≡ {S}_{o} \qquad ( 7 )$$

The total device “size” of all current paths is identical to the conventional driver circuit 700 and therefore should exhibit a very similar circuit speed.

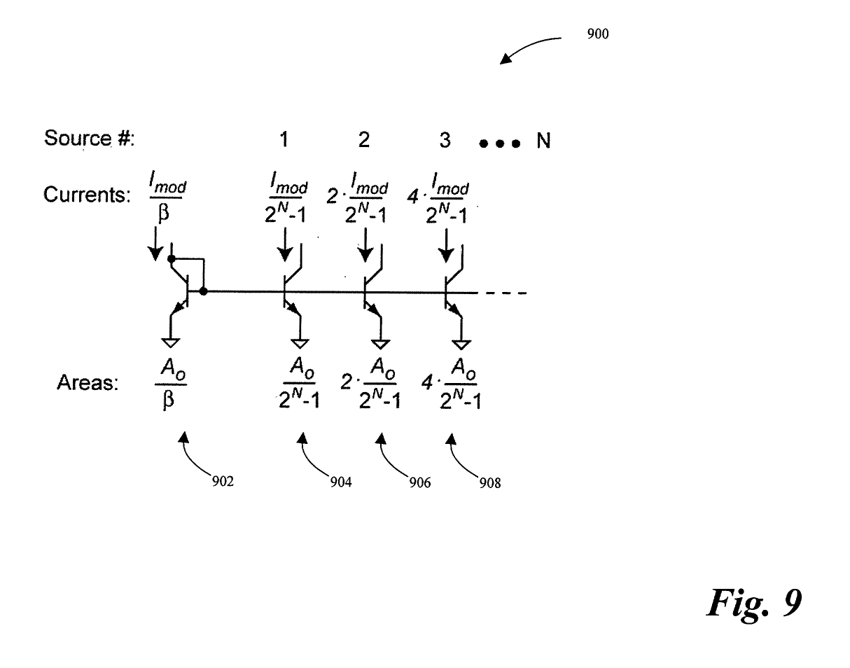

The plurality of current sources 804 shown in FIG. 8 can be conveniently realized by using scaled current mirrors as shown in FIG. 9. In the multilevel modulation circuit 900 of FIG. 9, the BJT device area is scaled to provide precise current scaling. A current injected into a reference BJT 902 will be “mirrored” as per area ratios to the multiple BJT current source outputs 904-908. The injected current on the reference BJT 902 sets the current range for the circuit 900. The actual input current used to control the plurality of sources can be scaled as desired by a scaling factor β. Those skilled in the art will appreciate that if FET devices are used to realize this circuit, the FET widths can be similarly scaled.

This circuit 900 is a high-output-current multilevel modulator, which can be applied to a variety of applications including the driving of laser diodes. In particular, if the laser diode shown in FIG. 8 was replaced with a load resistor, the binary controlled current would be converted to a voltage, thereby enabling the drive of other voltage-controlled optical modulators (e.g., a Mach-Zehnder modulator). The inventors contemplate that this exemplary embodiment of the multilevel modulator 900 can be used to directly drive an optical source or to drive another pre-compensation networks, which subsequently drive the optical source.

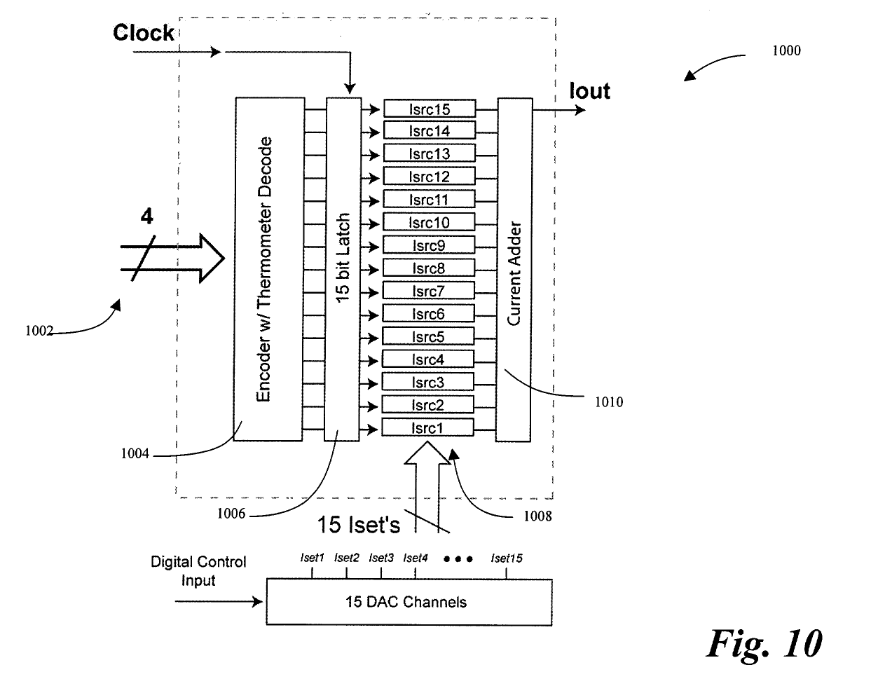

FIG. 10 is a block diagram depicting the architecture of an exemplary embodiment of the present invention. This improved architecture allows for the adjustment of each output level and provides for a higher fidelity (glitch free) output. In FIG. 10, an example of a 4-bit (16 output levels) multilevel modulator 1000 is shown. Those skilled-in-the-art will appreciate that the ideas presented here can be applied to multilevel modulation of any number of input bits. The four input bits 1002, which specify one of 16 desired output levels (i.e., transmitter output), are input to an encoder 1004 and first encoded with the desired level code (e.g., a Q-Gray code) and then thermometer decoded to the 15-lines feeding the 15-bit latch 1006. The 15-bit latch time synchronizes the 15-decoder outputs so that the 15 substantially identical current sources (labeled Isrc,i) 1008 can be synchronously activated and deactivated for high-fidelity signal generation around the transition point in time. Notably, a 15-bit architecture is used to produce 16 output levels, because the 15-bit architecture corresponds to the 15 steps that divide the 16 levels. The 15 substantially identical current sources can be used to achieve high fidelity signal generation. Those skilled in the art will appreciate that non-identical current sources could be used with less desirable, but acceptable, results.

All 15 of the Isrcs 1008 are identical circuits with adjustable current settings. The adjustable current sources 1008 can be of fixed value as determined by simple electronic circuits (i.e. resistors) or be adjusted by low-speed high-resolution circuits (e.g., digital-to-analog converters). These adjustable current settings allow for the current step between levels to be adjusted as required for linearization or as desired for other system considerations. Table 1 depicts an exemplary association of activated current sources to input word codes (e.g., Q-Gray code). The outputs of the 15 current sources are added together to form the output by a current adder 1010. This adder 1010 may be implemented in various ways, including a simple common wire connection or by a common connection to an emitter of a common base amplifier. The total output current for any applied input word will be the sum of the activated current sources:

$${I}_{out} = {\sum }_{i = 1}^{L} {I}_{src , i} \qquad ( 1 )$$

TABLE 1

| | Data | | | | Isrc, i | | | | | | | | | | | | | | |
|---|---|---|---|---|---|---|---|---|---|---|---|---|---|---|---|---|---|---|---|
| L | A | B | C | D | 1 | 2 | 3 | 4 | 5 | 6 | 7 | 8 | 9 | 10 | 11 | 12 | 13 | 14 | 15 |
| 16 | 1 | 0 | 0 | 0 | On | On | On | On | On | On | On | On | On | On | On | On | On | On | On |
| 15 | 1 | 0 | 1 | 0 | On | On | On | On | On | On | On | On | On | On | On | On | On | On | Off |
| 14 | 1 | 1 | 1 | 0 | On | On | On | On | On | On | On | On | On | On | On | On | On | Off | Off |
| 13 | 1 | 1 | 0 | 0 | On | On | On | On | On | On | On | On | On | On | On | On | Off | Off | Off |
| 12 | 0 | 1 | 0 | 0 | On | On | On | On | On | On | On | On | On | On | On | Off | Off | Off | Off |
| 11 | 0 | 1 | 0 | 1 | On | On | On | On | On | On | On | On | On | On | Off | Off | Off | Off | Off |
| 10 | 1 | 1 | 0 | 1 | On | On | On | On | On | On | On | On | On | Off | Off | Off | Off | Off | Off |
| 9 | 1 | 0 | 0 | 1 | On | On | On | On | On | On | On | On | Off | Off | Off | Off | Off | Off | Off |
| 8 | 1 | 0 | 1 | 1 | On | On | On | On | On | On | On | Off | Off | Off | Off | Off | Off | Off | Off |
| 7 | 1 | 1 | 1 | 1 | On | On | On | On | On | On | Off | Off | Off | Off | Off | Off | Off | Off | Off |
| 6 | 0 | 1 | 1 | 1 | On | On | On | On | On | Off | Off | Off | Off | Off | Off | Off | Off | Off | Off |
| 5 | 0 | 1 | 1 | 0 | On | On | On | On | Off | Off | Off | Off | Off | Off | Off | Off | Off | Off | Off |
| 4 | 0 | 0 | 1 | 0 | On | On | On | Off | Off | Off | Off | Off | Off | Off | Off | Off | Off | Off | Off |
| 3 | 0 | 0 | 1 | 1 | On | On | Off | Off | Off | Off | Off | Off | Off | Off | Off | Off | Off | Off | Off |
| 2 | 0 | 0 | 0 | 1 | On | Off | Off | Off | Off | Off | Off | Off | Off | Off | Off | Off | Off | Off | Off |
| 1 | 0 | 0 | 0 | 0 | Off | Off | Off | Off | Off | Off | Off | Off | Off | Off | Off | Off | Off | Off | Off |

Advantageously, the multilevel modulator of exemplary embodiments of the present invention enables the independent, level-by-level adjustment of the step heights between adjacent output levels. The exemplary embodiments of the present invention also can be implemented with a set of latches after thermometer decoding prior to the plurality of adjustable current sources to produce a high fidelity output (also known as “deglitching”). The exemplary multilevel modulators also can be implemented with a large output drive capable of direct drive of communication laser diodes.

The level-by-level adjustment enables the linearization of a multilevel modulated output signal, but can also be used to modify the output signal in other ways. For example, the adjustment might be adaptive, such that the independent level adjustments are made in response to a determination of the effect on the output signal. A buffer can be used to monitor the effects of the adjustments on the output signal. Advantageously, adaptive adjustment can be used to counteract the effects of various adverse influences on the output signal.

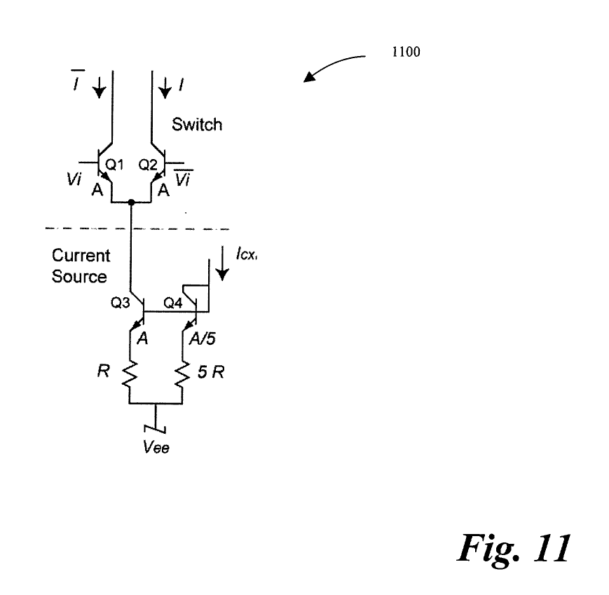

An exemplary embodiment of the current source (Isrc) circuit design 1100 is shown in FIG. 11. In this embodiment, the switched adjustable current source 1100 is implemented using bipolar transistors. A conventional current mirror (Q3 and Q4) forms the current source with an external constant-current reference provided by an external circuit (i.e. a conventional DAC). The current mirror (Q3 and Q4) is shown to have a 5-to-1 output-to-input ratio as an example of a typical power efficient design. The output of the current source is switched by using a conventional differential transistor pair (Q1 and Q2).

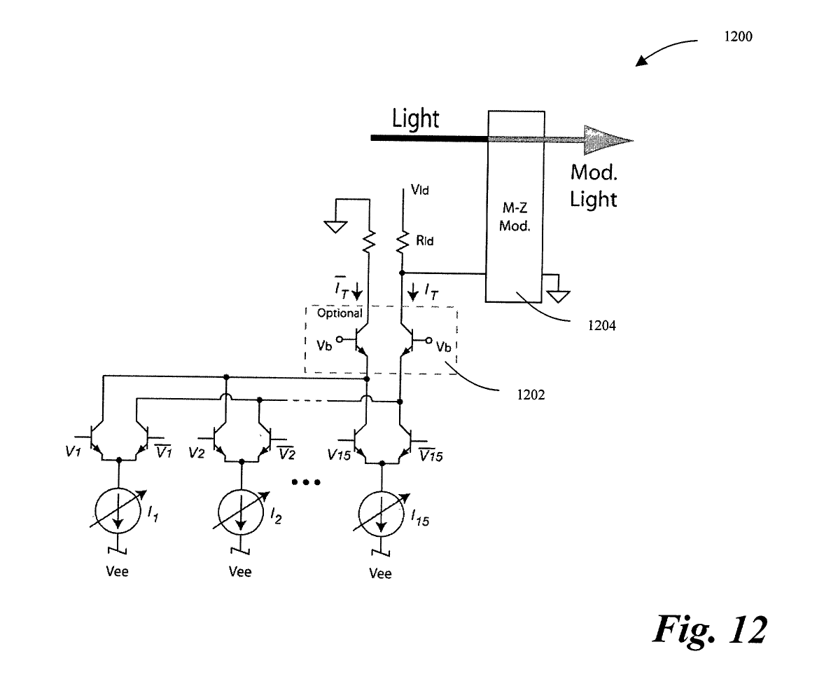

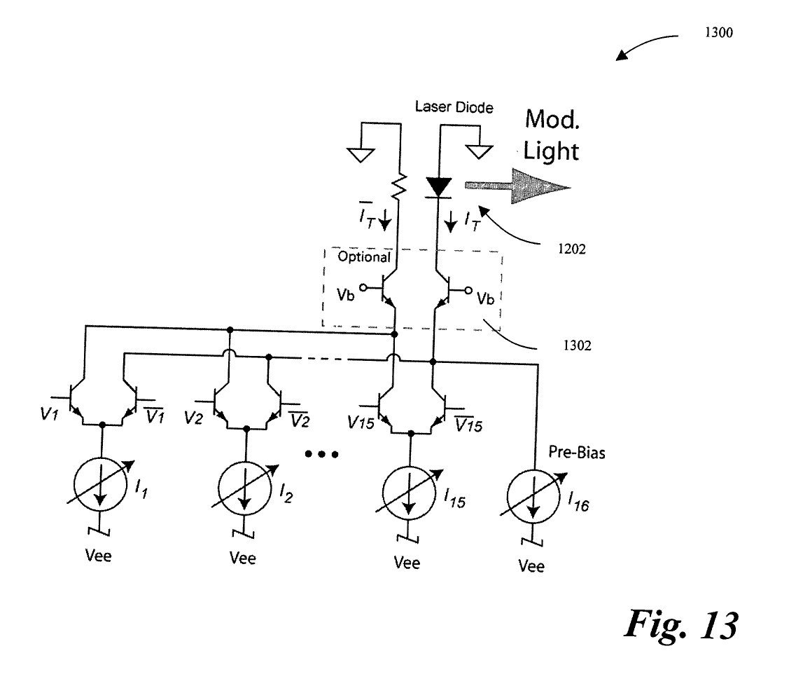

FIG. 12 is a schematic diagram of an adjustable binary-weighted multi-output current source laser drive circuit 1200 for a Mach-Zender interferometer-type coherent light modulator that is an exemplary embodiment of the present invention. FIG. 13 is a schematic diagram of an adjustable binary-weighted multi-output current source laser drive circuit for a direct-modulation laser diode. The exemplary circuits depicted in both of these figures use a common base amplifier 1202, 1302 to provide an improved current adder of the 15 Isrc outputs. The use of this optional common base amplifier 1202, 1302 provides an improved method of driving higher impedance loads. That is, when the optional amplifier is not present the output speed will be speed-limited by the RC time constant of the load resistance and the output capacitances of the Isrc's plus the common node interconnections. On the other hand, when the optional common base amplifiers are present the plurality of current sources see a very low impedance and the resulting RC time constant is very substantially diminished. For proper operation, a common base amplifier voltage, Vb, is a fixed DC bias set to allow for maximum output dynamic range and this results in the emitter being held at an approximately constant voltage of Vb-Vbe.

As shown in FIG. 12 the voltage drive for a Mach-Zender interferometer-type laser modulator 1204 (M-Z modulator) can be developed across a resistor, Rld, with the addition of an appropriate bias voltage, Vld, as required to bias the M-Z modulator within it's operating range.

As shown in FIG. 13 a laser diode 1304 can be directly driven by the multilevel modulator of the present invention. A pre-bias current source, I16, may be added to bias the laser above its threshold current as is typically done for good laser performance. The desired response curve of the laser can be similarly configured by current source adjustment as was discussed above in connection with the M-Z modulator depicted in FIG. 12.

Although the present invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method for representing a digital input word as a multilevel modulated output signal having one of n levels, the method comprising the steps of:
encoding the digital input word into a code having at least one bit;
switching a plurality of output sources, each output source corresponding to at least one bit of the code;
independently adjusting each of the output sources; and
adding the output sources to generate the multilevel modulated output signal.

2. The method of claim 1, wherein encoding the input word comprises associating the input word with a Q-Gray code.

3. The method of claim 1, wherein the step of encoding the digital input word comprises using a thermometer decoding method.

4. The method of claim 1, wherein the output sources are current sources.

5. The method of claim 1, wherein the output sources are voltage sources.

6. The method of claim 1, wherein the multilevel modulated output signal is used to drive a Mach-Zender interferometer-type light modulator.

7. The method of claim 1, wherein the multilevel modulated output signal is used to drive a laser diode.

8. The method of claim 1, wherein the output sources represent steps between the n levels of the output signal.

9. The method of claim 1, wherein the step of independently adjusting each of the output sources comprises adjusting each of a plurality of current sources.

10. The method of claim 9, wherein the current sources are substantially identical.

11. The method of claim 1, further comprising the step of latching each bit of the code, prior to switching a corresponding output source.

12. The method of claim 1, wherein the step of adding the output sources is performed by a common base amplifier.

13. A multilevel modulator for transmitting an output signal representing a digital input word having n bits over an optical fiber communication system, comprising:
an encoder circuit for associating the digital input word with a multilevel modulated output code;
at least one independently adjustable current source for representing each bit of the output code as a current level; and
a current adder for combining the current levels of the at least one independently adjustable current source to generate the output signal.

14. The multilevel modulator of claim 13, wherein the output code is a Q-Gray code.

15. The multilevel modulator of claim 13, wherein the encoder circuit comprises a thermometer decoder.

16. The multilevel modulator of claim 13, wherein the output signal can be used to drive a Mach-Zender interferometer-type light modulator.

17. The multilevel modulator of claim 16, wherein the output signal is converted to a voltage output.

18. The multilevel modulator of claim 13, wherein the output signal can be used to drive a laser diode.

19. The multilevel modulator of claim 13, wherein the current adder is a common base amplifier.

20. The multilevel modulator of claim 19, wherein the common base amplifier is operative to maximize the bandwidth of the output signal.

21. The multilevel modulator of claim 13 further comprising a pre-bias current source, wherein the current adder combines the pre-bias current with the at least one independently adjustable current source to generate the output signal.

22. A transmitter for use in an optical fiber communications system, comprising:
a multilevel modulation circuit operative to encode an input word into a multilevel modulated output code, the multilevel modulation circuit having a plurality of independently adjustable current sources, each current source corresponding to at least one bit of the output code, wherein the output of the current sources are added to generate the output signal; and
an optical source for transmitting the output signal over a link of the optical fiber communications system.

23. The transmitter of claim 22, wherein the output code is a Gray code.

24. The transmitter of claim 22, wherein the output code is a Q-Gray code.

25. The transmitter of claim 22 further comprising a current adder for combining the current levels of the independently adjustable current sources into the output signal.

26. The transmitter of claim 22 further comprising a common base amplifier operative to maximize the bandwidth of the output signal.

27. The transmitter of claim 22, wherein the output signal can be used to drive a Mach-Zender interferometer-type light modulator.

28. The transmitter of claim 27, wherein the output signal is converted to a voltage output.

29. The transmitter of claim 22, wherein the output signal can be used to drive a laser diode.

30. A method for representing a digital input word as a multilevel modulated output signal having one of a plurality of output levels, the method comprising the steps of:
receiving an input word;
encoding the input word into a code corresponding to one of the plurality of output levels, the code being operative to control a plurality of associated signal sources;
generating a source output for each signal source;
independently adjusting at least one of the source outputs; and
combining the source outputs to generate the multilevel modulated output signal.

31. The method of claim 30, wherein the steps of independently adjusting at least one of the source outputs results in the generation of a linearized multilevel modulated output signal.

32. The method of claim 30, wherein the steps of independently adjusting at least one of the source outputs results in the generation of a non-linear multilevel modulated output signal.

33. The method of claim 30, wherein the step of independently adjusting at least one of the output sources is based on a determination of an effect of the independent adjustment.

34. The method of claim 30, wherein the multilevel modulated output signal represents one of n levels.

35. The method of claim 34, wherein the code is operative to control n−1 signal sources.

36. The method of claim 34, wherein the code is operative to control n signal sources.
